(19) United States
(12) Patent Application Publication
(10) Pub. No.: US 2007/0268110 A1
(43) Pub. Date: Nov. 22, 2007

(54) Bi-Directional Radio Monitoring System

(75) Inventor: Anthony Russell Little, Parkdale (AU)

Correspondence Address: QUINE INTELLECTUAL PROPERTY LAW GROUP, P.C., P O BOX 458, ALAMEDA, CA, 94501, US

(73) Assignee: Australian Arrow PTY Ltd.

(21) Appl. No.: 11/660,024

(22) PCT Filed: Aug. 4, 2005
(86) PCT No.: PCT/AU05/01167

§ 371 Date: Feb. 8, 2007

(30) Foreign Application Priority Data
Aug. 10, 2004 (AU) 2004904542

(51) Int. Cl. B60R 25/10; G06F 7/04

(52) U.S. Cl. 340/5.62; 340/5.1; 340/5.61; 340/5.8; 455/41.2

(57) ABSTRACT

A bi-directional radio monitoring system includes a base unit (14) having a base RF transceiver (15) with two or more fixed antennae (17, 18, 19) associated therewith. The base unit communicates with a portable transceiver (16) using ultra high frequency (UHF) radio signals whereby, by using the two or more antennae (17, 18, 19), the base unit (14) is able to determine a relative position of the portable transceiver (16), depending on the closeness of the movable transceiver (16) to each of the fixed transceiver antennae (17, 18, 19). The RF signal transmission by the base unit (14) may vary in terms of channel, power, packet length, data rate and packet contents transmitted from each antennae (17, 18, 19) to give rise to responses from the portable transceiver (16) that enable the base unit (14) to track the movement of the portable transceiver (16).

### FIELD OF THE INVENTION

This invention relates to a radio monitoring system for equipment or equipment functions and relates particularly to a short range monitoring system that uses bi-directional radio communications in a variety of functional applications. The invention is particularly suitable for use in a passive access system to allow authorised access to a restricted area.

### BACKGROUND OF THE INVENTION

While the invention has broad application, it will be described with particular reference to a passive access system which uses an electronic access device, preferably a portable device, that communicates with a base controller to negotiate access to the restricted area., such as access or entry to a motor vehicle, building, room, container or the like. It will be understood, however, that the broader applications of the invention include monitoring equipment such as that associated with a motor vehicle, for example, tyre pressure monitoring, equipment status monitoring and the like. In its application to a passive access system, the invention may be adapted for use in relation to access or entry to any form of restricted area or space, including, as indicated, buildings, rooms, and containers of all types, as well as other vehicles and equipment including aircraft, cranes, mining equipment and the like. Accordingly, the following description should be read with the understanding that the invention is not limited to the particular applications described herein.

### DESCRIPTION OF PRIOR ART

Passive access systems have been previously proposed to facilitate authorised access to a motor vehicle. In one such system, a user initiates an access communications protocol by, for example, touching part of the vehicle, lifting a door handle or, in some instances, approaching to within a predetermined distance from the vehicle, such as is proposed in DE 44 35 894 A1. When the access communications protocol is initiated, a radio or other electromagnetic signal is transmitted by a transmitter associated with a base controller in the vehicle. The authorised person will be carrying a transponder which responds to the transmitted radio or other electromagnetic signal by transmitting a response that contains an identification or authorised response code. The received response is checked and authenticated by the base controller which then initiates one or more actuators to facilitate vehicle access.

In use, more than one transponder may be in close proximity to the vehicle when the base controller transmits its signal. Consequently, each transponder within range will respond to that transmitted signal and the base station will therefore receive a plurality of response signals. Such signals may be received in a manner to interfere with each other so that, consequently, the base station may be unable to recognise and identify a correct individual identifying signal.

It has been proposed to use time slots for individual response signals of a plurality of transponders to enable separation of individual signals. However, when multiple transponders, such as those associated with a car pool, are in use, long delays may then be experienced before access to the vehicle is authorised. Such delays are undesirable in practice.

Because of power consumption limitations, it has been proposed that passive access systems use a “trigger” to activate the communication protocol, such as touching the vehicle, moving a door button or handle, using capacitive sensors or the like. Australian patent application No. 731480 discloses a system that uses a capacitance sensor integrated into the door handle grip to sense a user's hand adjacent the grip. Once triggered, the vehicle then searches for the access device carried by the authorised user, and, on establishing an authenticated communications protocol, the system allows vehicle access. Such systems require that the transponder to be in close proximity to the vehicle to receive the initial transmission. Thus, most systems require the device to be within a distance of between 0.05 and 3 metres.

It has also been proposed to ensure that the access device, or transponder, is not within a vehicle prior to locking the vehicle. Australian patent specification No. 772048 discloses a system that, when a locking command is generated by operation of an operating element, a search signal is transmitted by a transmitter/receiver to determine the position of a transponder. If the transponder is within the vehicle, an indicating means is actuated to warn the user. A further operation of the operating element causes the vehicle to lock.

Such a system may also be set up to prevent the vehicle being started without a transponder being present within the vehicle.

With such a system, a low frequency radio signal may be used to determine the access device location as such a signal has a suitable short range RF field and the transponder can be developed with a very low power low frequency receiver. However, such systems are unsuitable for “entry on approach” as distinct from the “trigger to activate” due to power consumption requirements. An “entry on approach” feature allows a user with an access device to approach the vehicle and the vehicle will automatically unlock without requiring a trigger as referred to above. Such an “entry on approach” feature, as previously proposed, however, requires substantial power consumption for the vehicle and/or the access device and/or have been either impractical or too slow to respond in an applicable time period.

### SUMMARY OF THE INVENTION

It is desirable to provide a radio monitoring system which obviates at least some of the difficulties or disadvantages of previously proposed systems.

It is also desirable to provide a passive access system for vehicles or other restricted areas which obviates at least some of the difficulties or disadvantages of previously proposed systems.

It is also desirable to provide an improved passive access system which can support two or more portable access devices without incurring long communication periods.

It is also desirable to provide an improved passive access system for a vehicle which reduces power consumption both in the vehicle and the access device.

It is also desirable to provide an improved passive access system which has flexible and enhanced functionality.

It is also desirable to provide an improved passive access system which is economic to design, implement and install in a motor vehicle either as initial equipment or as after-market equipment.

It is also desirable to provide a radio monitoring system that has wide application to monitor equipment or equipment functions associated with a vehicle, workplace or otherwise.

According to an aspect of the invention there is provided a radio monitoring system including a base unit that includes at least one base RF transmitter/receiver (transceiver), at least two relatively fixed transmitter/receiver antennae associated with the base unit, and at least one transmitter/receiver (transceiver) unit movable relative to said transceiver antennae, said transceiver unit communicating with said base unit using ultra high frequency (UHF) radio signals whereby the base unit is able to determine at least an approximate relative position of the movable transceiver unit.

In one form, the approximate relative position of the movable transceiver unit is determined by each transceiver antennae transmitting signals that are received by the movable transceiver unit as stronger and weaker signals, depending on the closeness of the movable transceiver unit to one or other of the relatively fixed transceiver antennae. The movable transceiver unit responds in a manner that enables the base unit to determine a position approximation. Further signal transmissions and responses enable the base unit to track the movement of the movable transceiver unit.

According to another aspect of the present invention there is provided a passive access system comprising a base controller that includes at least one base RF transmitter/receiver (transceiver), at least two transceiver antennae associated with the base controller, and at least one portable access device incorporating an ultra-high frequency (UHF) transmitter/receiver. It is possible for any one of the transceivers/antennae to initiate communications.

In a further aspect of the invention there is provided a passive access system comprising:
a base controller unit,
at least two base transceiver antennae associated with the base unit,
at least one portable access device incorporating an ultra high frequency (UHF) transmitter/receiver (transceiver),
means initiating a UHF communications protocol between the access device and the base unit whereby at least the approximate relative position of the access device is ascertained by the base unit.

In one form of the invention, the base controller is located within a motor vehicle and has multiple transceivers forming a relative positional reference system whereby the relative position of the access device may be determined with the use of the communication signal transmissions. By simultaneously transmitting from two or more vehicle transmitter antennae, regions of interference and regions of signal domination are created. By varying the transmissions from the vehicle antennae, the access device will reject one or more of those transmissions. For example, if two simultaneous transmissions of equal power levels are made from different antennae, and the access device is very close to one of the transmitting antennas, the access device is most likely to receive the signal from the closer stronger signal and reject the weaker signal. The response made by the access device will relay to the base controller which signal response was made which will enable the base controller to assess that the access device was closer to one antennae than the other, thereby indicating its relative position.

Alternatively, if the received signal strength from both antenna transmissions are approximately equal, the access device will be unable to decode either transmission, indicating the access device is at approximate equal distances from the two transmitting antennae.

By using multiple UHF transceivers to determine the access device position relative to the vehicle, difficulties with excessive power consumption experienced by prior art systems are, to a large extent, alleviated or minimised.

Unlike low frequency (LF) communications, the use of a UHF frequency at very high data rates, for example 2.4 to 2.5 GHz with a data rate of 1 Mbit/sec, can support frequent transmissions at a suitable lower power consumption level. In addition, unlike LF communications, a bi-directional UHF system is likely to be significantly lower in cost to design, manufacture and install into a vehicle or elsewhere.

By using the concepts of the invention, the transceivers can vary transmitting power, data rates, packet length and deviate the frequency transmitted to generate different reception conditions for the access device. The known relative positions of the vehicle antennae are then used to determine the unknown relative position of the access device by the differential in the received signal. The 2.4 to 2.5 GHz nominal frequency has been chosen due to its world-wide global communications compliance, support for a high data rate, and availability of associated channels to support high security frequency hopping protocols.

In a further modification of embodiments of the invention, a system uses four transceivers on the vehicle (referred to as antennae), one transceiver in an access device, and a base controller. Three of the vehicle antennae form fixed references for range determination. One antenna is located in the left rear-vision mirror, one in the right rear-vision mirror and a third in the centre of the rear parcel shelf, or an equivalent location. This transceiver triangle forms the basis of determining the two-dimensional position of the access device. The fourth antenna is required and used in conjunction with the other three antennae to determine if the access device is located inside or outside the vehicle cabin with greater accuracy.

The base controller interfaces to the vehicle and may also process results from transmissions and define the conditional functional requirements. This base controller may also be integrated with an antennae module. In one embodiment, the access device periodically transmits an RF identifier signal once or multiple times and then listens for a response. If the access device is not within range of the vehicle, no response is received and the device reverts to a very low power shutdown mode until the next scheduled identifier transmission. Such transmissions may be made, for example, once per second, or more frequently or less frequently as may be desired in any particular application. Such polling transmissions include an identification code so that the access device is able to be recognised.

Thus, the access device will periodically transmit a signal and, when within range of a vehicle, the vehicle will initiate a protocol to identify the access device and determine its position in relation to the vehicle. The vehicle transmissions may include specifications for transmitting a response including channel, power level, data rate, packet length and packet contents, or specify a mode of operation.

The vehicle will transmit a series of packets from one or more antennae to successively determine the position of the access device relative to the vehicle. By tracking the access device position and trajectory, the base controller can determine if the access device is approaching or departing the vehicle and determine whether to lock or unlock the vehicle doors, and which doors should be effected. This can be extended to determining if the access device is approaching to access a particular door or the boot of the vehicle, and act accordingly.

If two or more access devices are present when the vehicle driver preferences are required, the vehicle can determine by prior trajectory history and/or by location which access device is likely to be the driver, or by the person which approached the driver's door and therefore invoke the correct driver preferences, including a seat position, mirror positions, radio settings and the like.

Lower power communication protocols may also be developed to prevent the base controller attempting to track the access device constantly, with the aim of reducing unnecessary power consumption. Thus, if the access device is left within proximity of the vehicle for a predetermined period, without moving, the system may enter a stand-by mode. Other strategies may involve the use of movement sensors and/or activity profiles. A movement sensor can detect if the access device is moving, or has moved within a predetermined period, to determine its polling period. Thus, if a movement sensor indicates no movement for a predetermined time, the polling period may be increased to ten or twenty seconds or more. As soon as a movement sensor indicates movement, the polling period may be decreased to the normal preset period. Similarly, an activity profile can reduce the frequency of the access device polling transmissions during periods where the access device has historically had less usage. This may be during certain periods during the day, such as at night-time, or some other profile may be programmed into the access device for varying the polling transmission frequency.

In addition to the passive access system, an access device may also support normal remote keyless entry whereby pressing a button on the access device can lock and unlock the vehicle, open the boot, remotely start the vehicle, and the like. Communicating between the vehicle's fixed transceivers to provide a reference for the access device can also compensate for ambient conditions. Therefore, remote keyless entry range and range consistency can be controlled, eliminating reception nulls, as well as improving range determination accuracy.

It is a further feature of the present invention that a vehicle fitted with the components required for implementation of the present invention will include a high-data rate, bi-directional wireless transceiver which may further be utilized for wireless diagnostics being implemented using the same hardware. Thus, the hardware of the present invention provides increased functionality and versatility in vehicle design and wireless technology implementation.

In another embodiment of the invention, the wireless transceiver system of the invention is used for tyre pressure monitoring, whereby a transmitter on the same UHF frequency as the base controller is mounted in the tyre or wheel system to relay pressure and/or temperature data to the base controller. This system obviates the need for separate additional receivers for tyre sensors. The system enables a determination of the position of the transmission from a tyre or wheel sensor, with respect to the vehicle, to thereby determine which tyre is relaying data, notwithstanding that the wheel may have been re-located to a different position on the vehicle during a service.

In order that the invention is more readily understood, embodiments thereof will now be described with reference to the accompanying drawings.

### DESCRIPTION OF THE DRAWINGS

FIG. 1 is a schematic illustration of one embodiment of the present invention,

FIG. 2 is a block diagram of a system according to the embodiment of FIG. 1,

FIG. 3 is schematic plan view of a second embodiment of the invention, and

FIG. 4 is a schematic view of an embodiment of the invention that includes tyre pressure/temperature sensors.

### DESCRIPTION OF THE PREFERRED EMBODIMENTS

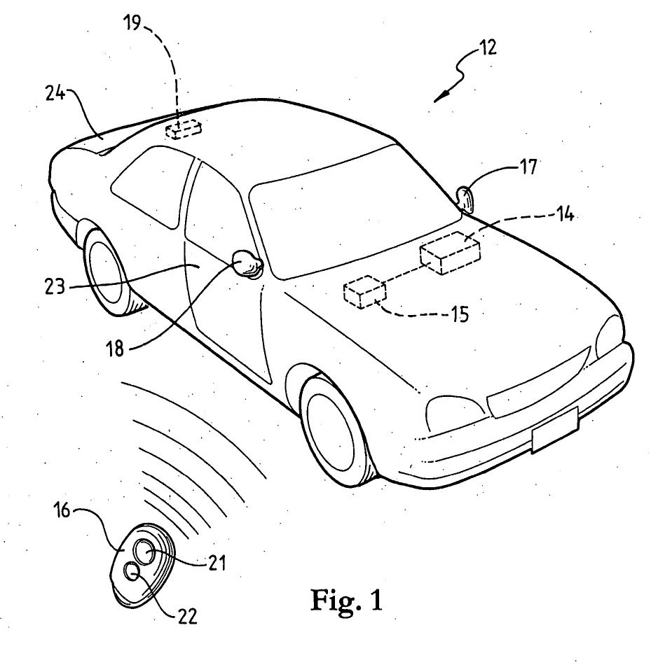

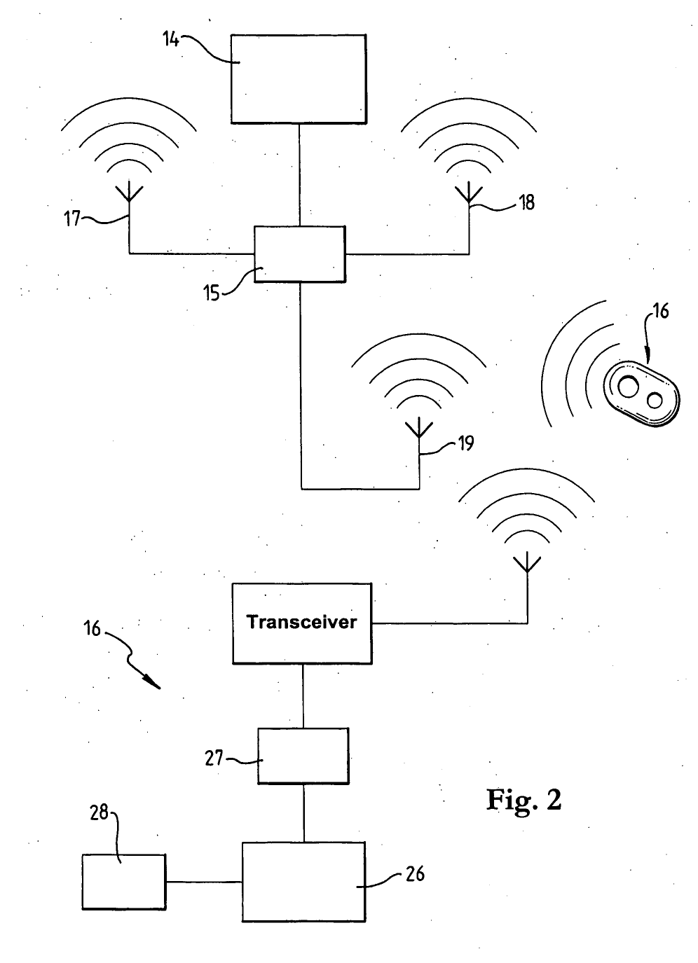

Referring to FIGS. 1 and 2 , this embodiment of the invention will be described with reference to its use in relation to a motor vehicle 12. The vehicle has a base controller 14 which controls a high date rate, bidirectional wireless transmitter/receiver (transceiver) 15, which provides RF communications with one or more portable access devices 16. The portable access devices 16 each incorporate a transceiver, and they are also provided, in this preferred embodiment, with pushbuttons 21 and 22 which, on actuation, initiate RF signal generation which, on authentication, cause the base controller to lock or unlock a vehicle door 23 or boot (trunk) lid 24, in a known manner. Thus, the portable access device 16 enables remote keyless entry and locking of the vehicle 12.

The transceiver 15 in the vehicle 12 communicates with the transceiver in the access device 16 through at least two, and preferably three antennae which form fixed references. One antenna is located in the left rear-mirror 17, one located in the right rear-mirror 18 and one 19 located at the rear of the vehicle, preferably centrally on the parcel shelf or a central rear brake light fitting.

The transceiver 15 in the vehicle and the transceiver in the portable access device 16, receive and transmit radio communication signals in the ultra high frequency (UHF) range. Such transmissions have a relatively short range of between, for example, 3 and 30 metres, preferably 6 to 15 metres.

When a communication protocol is established between the transceiver 15 in the vehicle and an access device 16, by simultaneously transmitting from two or more vehicle transmitter antennae 17, 18 and 19, regions of interference and regions of signal domination are created. By varying the transmissions from the vehicle antennae, the access device 16 will reject one or more of those transmissions. For example, if two simultaneous transmissions of equal power levels are made from the antennae in the right hand mirror 18 and the rear antenna 19, and the access device 16 is very close to the transmitting antenna 18, the access device 19 will accept the closer stronger signal and reject the weaker signal. The response made by the access device 16 will relay to the base controller 14 which signal response was made which will enable the base controller 14 to determine that the access device 16 was closer to the antenna 18 than the other, thereby indicating its relative position.

Alternatively, if the received signal strength from both antennae transmissions are approximately equal, the access device 16 will be unable to decode either transmission, indicating the access device is at approximate equal distances from the two transmitting antennae 18 and 19.

The use of a UHF frequency at very high data rates, for example 2.4 to 2.5 GHz with a data rate of; for example, 1 Mbit/sec, can support frequent transmissions at a suitable low power consumption level.

The transceivers can, under control of the base controller 14, vary transmitting power, data rates, packet length and deviate the frequency transmitted to generate different reception conditions for the access device 16. The known relative positions of the vehicle antennae 17, 18 and 19 are then used to determine the unknown relative position of the access device 16 by the differential in the received signal.

In order to initiate the communication protocol, the access device 16 is programmed to continuously and periodically transmit a polling signal in the UHF range, preferably at about 2.4 GHz. A poll signal generator 27 is controlled by a programmed timer 26 to controls the frequency of and number of polling transmissions at a given time. The polling transmissions may occur at intervals of between 0.0025 seconds and 5 seconds, or greater. In a preferred embodiment, the access device 16 includes a movement sensor 28 and/or an activity profile either or both of which can vary the rate at which a polling transmission is made. If the access device 16 is not within range of the vehicle 12, no response to the polling signal is received and the device 16 reverts to a very low power shutdown mode until the next scheduled identifier transmission. Such transmissions may be made, for example, once per. second, or more frequently or less frequently as may be desired in any particular application. The access device 16 may be programmed to reduce the frequency of polling transmissions if the motion sensor 28 detects no movement of the access device 16 within a predetermined period or if an activity profile indicates a period of no activity. Thus, at such times, the polling frequency could reduce to 30 to 60 seconds between transmissions. All polling transmissions will include an identification code so that the access device 16 is able to be recognised.

If an authenticated polling transmission is received by the transceiver 15 associated with the base controller 14 in the vehicle 12, the controller 14 responds by transmitting at least one response UHF signal that contains instructions to the access device 16 for continuing to remain in a receiving mode, and/or together with specifications for transmitting a response including channel, power level, data rate, packet length and packet contents.

The transceiver 15 in the vehicle 12 then transmits, in UHF, a series of packets from one or more of the three external antennae 17, 18 and 19. These signals give rise to further communication from the access device 16 and the exchange of communication between the access device 16 and the various antennae 17, 18 and 19 enables the base controller 14 to locate, in two or three dimensions, the relative position of the access device 16. The access device 16 may also communicate its three dimensional orientation to improve the controller's 14 ability to determine the relative position of the access device 16. Preferably, the base controller 14 is also able to determine the direction of movement of the access device 16 by successively tracking the relative position of the access device 16. By tracking the access device 16, the base controller 14 is able to unlock a door on the side of the vehicle 12 at which the access device 16 is located.

If two or more access devices 16 are present when the vehicle 12 transmits a communication signal, coded responses enable the vehicle to recognise the presence of more than one access device 16 and provide instructional signals accordingly to thereby identify each individual access device 16 and, by determining prior trajectory history and/or location, determine which access device 16 is approaching the drivers door to thereby invoke correct driver preferences within the vehicle.

The vehicle transceiver 15 is controlled through the base controller 14. In an alternative arrangement, two or more transceivers are controlled by the base controller 14 through a master transceiver 15 which controls the other transceivers as to the signal transmissions, decoding of signals received and authentication.

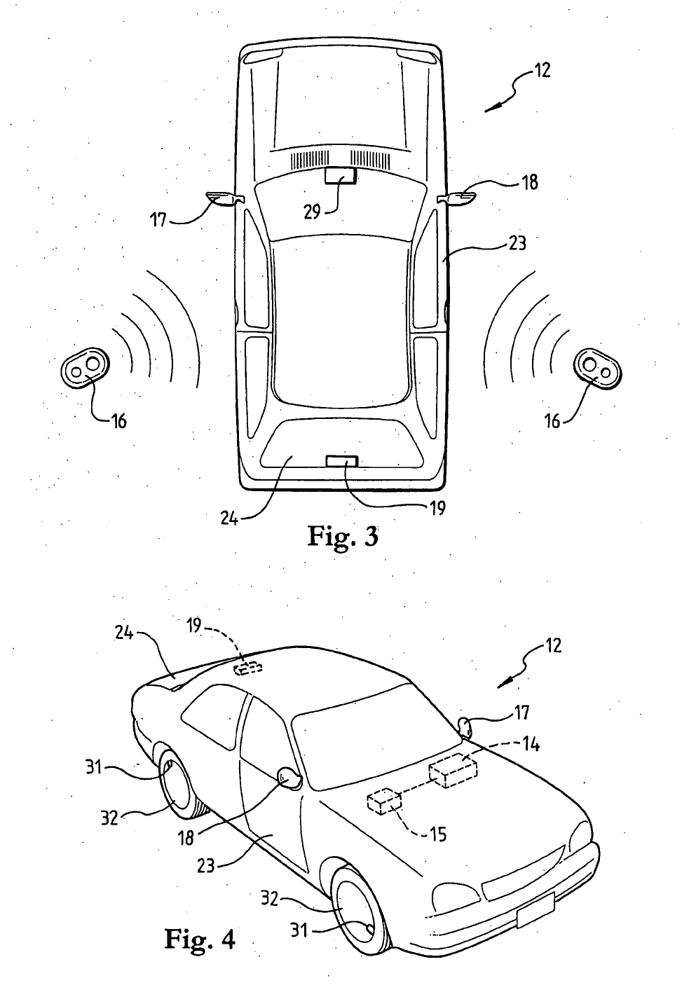

In an alternative form of the invention illustrated in FIG. 3, a fourth transceiver antennae 29 is located within the vehicle and is used in conjunction with the other three antennae 17, 18 and 19 to determine whether or not an access device 16 is inside or outside the vehicle cabin with greater accuracy. Such information is desirable to reliably ensure that the access device 16 is not inadvertently locked in the vehicle 12, or the vehicle is not started without the access device located inside the vehicle 12.

When the access device 16 is located within the vehicle, the fourth transceiver antenna 29 provides, together with the three external antennae, confirmation of the access device being within the vehicle so that vehicle operation is enabled.

It will be appreciated that while the particular embodiments of the invention described herein employ the use of a polled transmissions by the access device to initiate or trigger the base controller to transmit a communication signal to the device; other forms of initiating the communications signals may be used. For example, proximity sensors or other means for sensing the presence of the access device near the vehicle may be used.

Referring to FIG. 4, it is a further feature of embodiments of the invention that a vehicle 12 fitted with the components required for implementation of the present embodiments will include a high-data rate, bidirectional wireless transceiver 15 which may be further utilized for wireless diagnostics being implemented using the same hardware. Thus, the hardware of the present embodiments provides increased functionality and versatility in vehicle design and wireless technology implementation.

In this embodiment, the wireless transceiver system is used for tyre pressure monitoring, whereby a transmitter or transceiver 31 on the same UHF frequency as the base transceiver 15 is mounted in each tyre or wheel 32 to relay pressure and/or temperature data to the base controller 14. Each wheel has a transmitter 31, including spare wheels, which may be a transceiver, and the location of an individual transceiver 31 that generates a signal to the antennae 17, 18 and 19 is able to be determined by the base controller 14 to indicate the particular wheel 32 that gave rise to the warning signal. This system obviates the need for separate, additional receivers for tyre sensors. A further benefit is the ability of the system to determine the position of the transmission from a tyre or wheel sensor and therefore determine which tyre position is relaying data, notwithstanding that the wheel 32 may have been re-located during a vehicle service. This is an important aspect of monitoring tyre pressure without requiring individual systems or receivers for each tyre.

The controller 14 can determine if a wheel is missing and report to the vehicle's systems a missing wheel or wheels alert, which may be used for user warning and/or theft warning and reporting.

1. A radio monitoring system including comprising:
a base unit with at least one base RF transceivers;
at least two relatively fixed transceiver antennae associated with the base unite; and
at least one transceiver unit movable relative to said transceiver antennae, said movable transceiver unit communicating with said base unit using ultra high frequency (UHF) radio signals;
whereby the base unit is able to determine at least an approximate relative position of the movable transceiver unit.

2. The radio monitoring system according to claim 1, wherein each relatively fixed transceiver antennae transmits signals that are received by the movable transceiver unit as stronger and weaker signals, depending on the closeness of the movable transceiver unit to one or other of the relatively fixed transceiver antennae, whereby the approximate relative position of the movable transceiver unit is determined.

3. The radio monitoring system according to claim 2, wherein the movable transceiver unit responds in a manner that enables the base unit to determine a position approximation.

4. The radio monitoring system according to claim 1, wherein signal transmission variations of channel, power, packet length data rate and packet contents transmitted from each transceiver antennae give rise to responses from the movable transceiver unit that enable the base unit to track the movement of the movable transceiver unit.

5. A passive access system comprising.
a base controller unit with at least one base RF transceivers;
at least two transceiver antennae associated with the base controller unit; and,
at least one portable access device incorporating an ultra-high frequency (UHF) transceivers, with communication between the transceiver antennae and the portable access device transceiver being initiated by any one of the transceiver antennae, the portable access device, or the base RF transceiver.

6. A passive access system comprising:
a base controller unit with at least one base transceivers,
at least two base transceiver antennae associated with the base controller unit,
at least one portable access device incorporating an ultra high frequency (UHF) transceiver,
a means for initiating a UHF communications protocol between the portable access device and the base controller unit, whereby at least the approximate relative position of the portable access device is determined by the base controller unit.

7. The passive access system according to claim 37, wherein the base controller unit is located within a motor vehicle and comprises multiple transceivers forming a relative positional reference system, whereby the relative position of the portable access device may be determined with the use of he communication signal transmissions.

8. The passive access system according to claim 7, wherein simultaneous transmission of UHF communication signals from two or more vehicle transceiver antennae create regions of interference and regions of signal domination, and varying the transmissions from the vehicle transceiver antennae causes the portable access device to reject one or more of the transmissions and respond to one transmitted signal.

9. The passive access system according to claim 7, wherein two simultaneous communication signal transmissions of equal power levels are generated from two different transceiver antennae, and wherein the portable access device responds to a closer stronger communication signal and rejects a weaker communication signal, the response made by the portable access device being relayed to the base controller unit, whereby the base controller unit assesses a relative position of the portable access device.

10. The passive access system according to claim 7, wherein if received signal strengths from two equal powered simultaneous antenna transmissions are approximately equal, the portable access device is unable to decode either transmission and is unable to respond, thereby providing an indication to the base controller unit that the portable access device is at approximate equal distances from the two transmitting antennae.

11. The passive access system according to claim 7, wherein the UHF communication signal transmissions are made at a frequency of between 2.4 to 2.5 GHz with a data rate of about 1 Mbit/sec.

12. The passive access system according to claim 7, wherein each of the multiple transceivers varies transmitting power, data rates, and/or packet lengths and deviate the frequency transmitted to generate different reception conditions for the portable access device which responds differently to the various transmissions, thereby enabling the base controller unit to determine the unknown relative position of the portable access device.

13. The passive access system according to claim 7, wherein the base controller unit comprises four transceiver antennae which are positioned on the vehicle and which provide a fixed reference relative to the vehicle for range determination.

14. The passive access system according to claim 13, wherein a first antenna is located in a left rear-vision mirror, a second antenna in a right rear-vision mirror and a third antenna in a central rear location of the vehicle, wherein triangulation of the first, second and third antennae provides a two-dimensional position of the portable access device, and wherein a fourth antenna is located in the vehicle and used in conjunction with the first, second and third antennae to determine if the portable access device is located inside or outside the vehicle and improve range determination accuracy.

15. The passive access system according to claim 7 wherein the portable access device initiates a communication protocol by periodically transmitting an RF identifier signal once or multiple times and listens for a response.

16. The passive access system according to claim 15 wherein, if the portable access device is not within range of the vehicle, no response is received and the device reverts to a very low power shutdown mode until a next scheduled identifier transmission.

17. The passive access system according to claim 15, wherein identifier transmissions are made periodically, and include an identification code so that the portable access device is able to be recognised.

18. The passive access system according to claim 15, wherein the identifier transmissions are be made at intervals of between 0.0025 seconds and 5 seconds.

19. The passive access system according to claim 37 wherein the portable access device periodically transmits an identifier signal and, when within range of a-the vehicle, the base controller unit will receive the identifier signal, decode the identification code, and initiate a protocol to identify the portable access device and determine its position in relation to the vehicle.

20. The passive access system according to claim 7, wherein transmissions from the base controller unit include instructions for the portable access device to transmit a response, wherein the response comprises channel, power level, data rate, packet length and packet contents, or to specify a mode of operation.

21. The passive access system according to claim 7, wherein one or more vehicle transceiver antennae transmit a series of packets from the one or more antennae to successively determine the position and trajectory of the portable access device relative to the vehicle, whereby the base controller unit determines if the portable access device is approaching or departing the vehicle and determines whether to lock or unlock the vehicle doors, and which doors should be effected.

22. The passive access system according claim 7, wherein when two or more portable access devices are present and communicating with the base controller unit, the base controller unit determines by prior trajectory history and/or by location which portable access device is likely to be the driver, or by the person which approached the driver's door, and thereby invoke correct driver preferences, including a seat position, mirror positions and radio settings.

23. The passive access system according to claim 7 wherein when the base controller unit determines that the portable access device within proximity of the vehicle but is not moving relative to the fixed antennae, the system enters a standby low power mode.

24. The passive access system according to claim 7, wherein the p2ortable access device further comprises a movement sensor.

25. The passive access system according to claim 24, wherein the base controller unit and/or the p2ortable access device comprises an activity profile that determines a polling period based upon whether the portable access device is moving or has moved within a predetermined period.

26. The passive access system according to claim 25, wherein, if the movement sensor indicates no movement for a predetermined time, the polling period is increased to a longer duration.

27. The passive access system according to claim 26 wherein the polling period is decreased to a preset period upon detection of movement by the movement sensor.

28. The passive access system according to any one of claim 25 wherein an activity profile reduces the frequency of polling transmissions during periods where the portable access device has historically had less usage.

29. The passive access system according to claim 25, wherein:
a) the activity profile reduces a frequency of the portable access device polling transmissions during certain periods
b) the activity profile reduces the frequency of the portable access device polling transmissions during the day or night; or,
c) an alternate profile is programmed into the portable access device for varying the polling transmission frequency.

30. The passive access system according to claim 7, wherein the portable access device includes pushbuttons that support remote keyless entry, whereby pressing a button on the portable access device initiates lock and unlock functions of the vehicle, opens the boot or remotely starts the vehicle.

31. The passive access system according claim 7, wherein compensation for ambient conditions is provided in the communication transmissions between the transceiver antennae and the portable access devices to control consistency of remote keyless entry range and range, thereby eliminating reception nulls, and improving range determination accuracy.

32. The passive access system according to claim 7 wherein compensation for the portable access device's relative orientation to the vehicle is used to improve the range determination accuracy.

33. The passive access system according to claim 7 wherein proximity sensors or other sensing means for sensing the presence of the access device near the vehicle are used to initiate the communication protocol between the base controller unit and the portable access device.

34. The passive access system according to claim 7, wherein the vehicle base controller unit and transceiver is utilized for wireless diagnostics of vehicle equipment.

35. The passive access system according claim 7, further comprising additional transmitters mounted in a tyre or wheel system of the vehicle and transmitting pressure and/or temperature data to the base controller unit on a same UHF frequency wherein the base controller unit and base RF transceiver are used for tyre pressure monitoring and for generating an optional transmitted warning signal.

36. (canceled)

37. The passive access system according to claim 5, wherein an approximate relative position of the portable access device is determined by the base controller unit.
